(19) United States
(12) Patent Application Publication
(10) Pub. No.: US 2023/0338226 A1
(43) Pub. Date: Oct. 26, 2023

(54) Adjustable massage structure and massage backpack

(71) Applicant: Li Zhijian, Fuzhou (CN)

(72) Inventor: Li Zhijian, Fuzhou (CN)

(21) Appl. No.: 18/214,550

(22) Filed: Jun. 27, 2023

Related U.S. Application Data
(63) Continuation-in-part of application No. 17/575,930, filed on Jan. 14, 2022, now Pat. No. 11,723,831.
Application No. 17/575,930 is a continuation of application No. 17/486,988, filed on Sep. 28, 2021.
Application No. 17/486,988 is a continuation of application No. 16/693,259, filed on Nov. 23, 2019, now Pat. No. 11,426,324.
Application No. 16/693,259 is a continuation of application No. 16/850,043, filed on Apr. 16, 2020, now Pat. No. 11,344,469.
Application No. 16/850,043 is a continuation of application No. 16/885,324, filed on May 28, 2020, now Pat. No. 11,337,887.
Application No. 16/885,324 is a continuation of application No. 17/149,806, filed on Jan. 15, 2021.
Application No. 17/149,806 is a continuation-in-part of application No. 17/149,806, filed on Jan. 15, 2021.
Application No. 17/149,806 is a continuation-in-part of application No. 16/885,324, filed on May 28, 2020, now Pat. No. 11,337,887.
Application No. 16/885,324 is a continuation-in-part of application No. 16/850,043, filed on Apr. 16, 2020, now Pat. No. 11,344,469.
Application No. 16/850,043 is a continuation-in-part of application No. 16/693,259, filed on Nov. 23, 2019, now Pat. No. 11,426,324.
Application No. 16/693,259 is a continuation-in-part of application No. 16/693,452, filed on Nov. 25, 2019, now Pat. No. 10,888,494.
Application No. 17/149,806 is a continuation-in-part of application No. 16/850,043, filed on Apr. 16, 2020, now Pat. No. 11,344,469.
Application No. 16/850,043 is a continuation-in-part of application No. 16/693,452, filed on Nov. 25, 2019, now Pat. No. 10,888,494.
Application No. 16/693,452 is a continuation-in-part of application No. 16/693,259, filed on Nov. 23, 2019, now Pat. No. 11,426,324.
(60) Provisional application No. 62/834,551, filed on Apr. 16, 2019.
(60) Provisional application No. 62/854,261, filed on May 29, 2019.
(60) Provisional application No. 62/834,551, filed on Apr. 16, 2019.

(30) Foreign Application Priority Data
Jan. 11, 2019 (CN) 201910028229.9
Oct. 5, 2021 (CN) 202111240999.3

(51) Int. Cl. A61H 23/02; A45F 3/04

(52) U.S. Cl. CPC A61H 23/02; A45F 3/04; A61H 2205/081; A61H 2201/5007; A61H 2201/1207; A61H 2201/165; A61H 2201/5043; A45F 2003/045; A61H 2201/1626; A45F 2003/003

(57) ABSTRACT

A massaging apparatus system with a convenient manufacturing and removable structure, with a body with a first back panel and a second massage back panel, the second massage back panel is removable and attachable to the first back panel, the second massage back panel has a first inner layer, a second inner layer, a first outer layer and a second outer layer and at least one massage head, the first outer layer is configured to communicate with a users back for massage performance, the second outer layer is configured to attach to the first back panel by at least a pair of detachable accessories, the second massage back panel is flexible, between the first inner layer and the second inner layer there is at least one layer of flexible material and a control circuit having at least one cable connects to the at least one massage head.

This application is a continuation-in-part of application Ser. No. 17/575,930 filed Jan. 14, 2022, which is a continuation of and claims priority to Ser. No. 16/885,324 (now U.S. Pat. No. 11,337,887) filed May 28, 2020, application Ser. No. 17/575,930 is a continuation of and claims priority to Ser. No. 16/850,043 (now U.S. Pat. No. 11,344,469) filed Apr. 16, 2020, application Ser. No. 17/575,930 is a continuation of and claims priority to Ser. No. 16/693,259 (now U.S. Pat. No. 11,426,324) filed Nov. 23, 2019 which claims priority to provisional patent application 62/834,551 filed Apr. 16, 2019. This application is a continuation-in-part of application Ser. No. 17/149,806 filed Jan. 15, 2021 which in turn claims priority to Ser. No. 16/885,324 filed May 28, 2020 (now U.S. Pat. No. 11,337,887), Ser. No. 16/885,324 filed May 28, 2020 (now U.S. Pat. No. 11,337,887), Ser. No. 16/850,043 filed Apr. 16, 2020 (now U.S. Pat. No. 11,344,469), Ser. No. 16/850,043 filed Apr. 16, 2020 (now U.S. Pat. No. 11,344,469, Ser. No. 16/693,452 filed Nov. 25, 2019 (now U.S. Pat. No. 10,888,494), Ser. No. 16/693,452 filed Nov. 25, 2019 (now U.S. Pat. No. 10,888,494), Ser. No. 16/693,259 filed Nov. 23, 2019 (now U.S. Pat. No. 11,426,324), which in turn claim priority to provisional application 62/854,261 filed May 29, 2019 and 62/834,551 filed Apr. 16, 2019. This application is a continuation in part of Ser. No. 17/149,806 filed on Jan. 15, 2021 which is Pending and claims the benefit of 62/854,261 filed Jan. 15, 2021.

### TECHNICAL FIELD

The present invention relates to the field of backpacks, in particular, an adjustable massage structure and massage backpack for a close fit. After a series of innovative, fully considering the scientific, ergonomic and other factors, composite innovated the detailed sizes and structures, invented a more close-fitting, adjustable special and comfortable effect of the massage backpack.

### BACKGROUND TECHNOLOGY

Existing backpacks provide convenience for people to carry items on their trips, but still have the following defects: due to the weight of the items in the backpack, the backpacker's shoulders, back and waist are under pressure, and over time, the backpacker will feel uncomfortable and prone to fatigue and pain, which damages the user's health. With the advancement of technology, backpacks with massage function have been designed on the traditional backpack. The existing massage backpack is generally installed on the shoulder straps, and the massage position of the massage head is mostly by adjusting the elasticity of the shoulder straps to carry out, in the process of adjusting the elasticity of the shoulder straps in the backpack the up and down position on the human back also changed at the same time, the use experience is compromised, and only using the shoulder strap structure, the massage head and the human shoulder is not fit enough, massage effect is poor.

### CONTENT OF THE INVENTION

The purpose of the present invention is: to overcome the above shortcomings to provide an adjustable massage structure and massage backpack, the massage structure and massage backpack will be separated into the upper and lower back panel, and the upper part of a second set of webbing can be adjusted to the massage position of the massage head, and the second webbing on the shoulder straps to play a pulling role, so that the massage head can fit more closely with the human shoulder and back, massage effect is good.

The present invention is realized through the following technical solutions. Solution I. An adjustable and fit massage structure comprising a back panel and a shoulder strap set on the back panel, wherein the back panel further comprising a connected upper part and a lower part, the upper end of the shoulder strap being connected to the back panel at a position set on the connection line between the upper part and the lower part of the back panel, wherein the lower end of the shoulder strap being connected to the lower part of the back panel through a first webbing, the height h of the back panel being: h≥390 mm, the height d of the upper part being: 110 mm≤d≤147 mm.

Wherein the shoulder strap is provided with a massage head for back and shoulder massage inside, the shoulder strap is connected to the upper part of the back panel with a second webbing for adjusting the shoulder strap and the position of back and shoulder massage, wherein the second webbing is provided with a second adjustment part for adjusting the length of the second webbing.

Preferably, the number of shoulder straps is two and spaced along the width direction of the back panel. Preferably, wherein the second adjusting part is ladder buckle. In order to allow the second webbing to be adjusted to maintain accurate positioning of the back strap moving up and down, and not to induce left and right shaking, and when tightening, it will not resulting a reduced degree of intimacy, the two ends of the second webbing and the second adjustment part are close and located on the substantially same vertical surface.

In order to facilitate the installation of the massage head, the shoulder strap is provided with a storage space for the installation of the massage head, wherein the storage space is provided with a first opening on one side to facilitate the massage head and cable through it, the storage space is elastic and fastened to the outer circumference of the massage head.

In order to facilitate the disassemble of the massage head, the side wall of the shoulder strap is provided with a second opening for opening and closing the internal space of the shoulder strap, wherein the second opening is closed and connected by fasteners. Preferably, the shoulder strap is also provided with a fastening device to hold the second webbing to reduce noise, the fastening device can be an elastic band or hook and loop (Velcro®).

Solution II. A massage backpack comprising the fit adjustable massage structure described in Solution I and a bag body connected thereto, the bag body being fixed or detachably connected to the back panel. Compared with the prior technology, the beneficial effects of the present invention are. 1. the invention provides a close-fitting, adjustable massage structure and massage backpack, the massage structure and massage backpack comprises an upper and a lower part on the back panel, with a special size setting, and a second webbing set in the upper part can be adjusted to the massage position of the massage head, and the second webbing on the shoulder straps to play a pulling role, so that the massage head can fit more closely with the human shoulder and back position, through these multi-point organic coordination combinations makes, massaging effect getting better. And the invention and innovation of this product size, that is, the scientific combination of the back panel height and the upper part height size, is an important factor to achieve the effect of invented massaging backpack. 2. The present invention provides a fit and adjustable massage structure and massage backpack, wherein the two ends of the second webbing and the second adjustment component are close and located on the substantially same vertical surface. This way the second webbing can keep the positioning of the backpack moving up and down accurately when adjusting, without creating left and right shaking. It will not cause a gap between the back of the main body and the shoulder or back of the human body, when tighter the webbing which form a deviation. 3. The present invention provides a snug and adjustable massage structure and massage backpack, wherein an opening is set at the side of the shoulder strap and an elastic storage pocket is set inside the shoulder strap to facilitate the disassemble and assemble of the massage head. 4. The invention provides an adjustable massage structure and massage backpack, the massage structure and other parts of the backpack are independent structures, later the entire back system can be sewn directly to other parts to complete the backpack sewing, which can improve production efficiency.

### DESCRIPTION OF THE ATTACHED DRAWINGS

FIG. 1 is a schematic diagram I of the structure of implementation I of the present invention.

FIG. 2 is a schematic diagram of the structure of implementation I of the present invention II.

FIG. 3 is a schematic diagram of the structure of implementation I of the present invention III.

FIG. 4 is a schematic diagram I of the use state of implementation I of the present invention

FIG. 5 is a schematic diagram of the use state of implementation I of the present invention II.

Description of the marks: 1—back panel, 11—upper part, 12—lower part, 2—shoulder straps, 21—second opening, 3—first webbing, 31—first adjustment part, 4—massage head, 5—second webbing, 51—second adjustment part, 52—upper stitching, 53—lower stitching, 54—protruding section, 55—upper section, 56—a lower section, 6—storage pocket, 61—first opening, 7—fastening part, 8—fasteners.

FIG. 6 depicts the present invention.

FIG. 7 depicts the present invention.

FIG. 8 depicts the present invention.

FIG. 9 depicts the present invention.

FIG. 10 depicts the present invention.

FIG. 11 depicts the present invention.

FIG. 12 depicts the present invention.

FIG. 13 depicts the present invention.

FIG. 14 depicts the present invention.

FIG. 15 depicts the present invention.

FIG. 16 depicts the present invention.

FIG. 17 depicts the present invention.

FIG. 18 depicts the present invention.

FIG. 19 depicts the present invention.

FIG. 20 depicts the present invention.

FIG. 21 depicts the present invention.

FIG. 22 depicts the present invention.

### SPECIFIC IMPLEMENTATIONS

The present invention is described in detail below in conjunction with the accompanying illustrations.

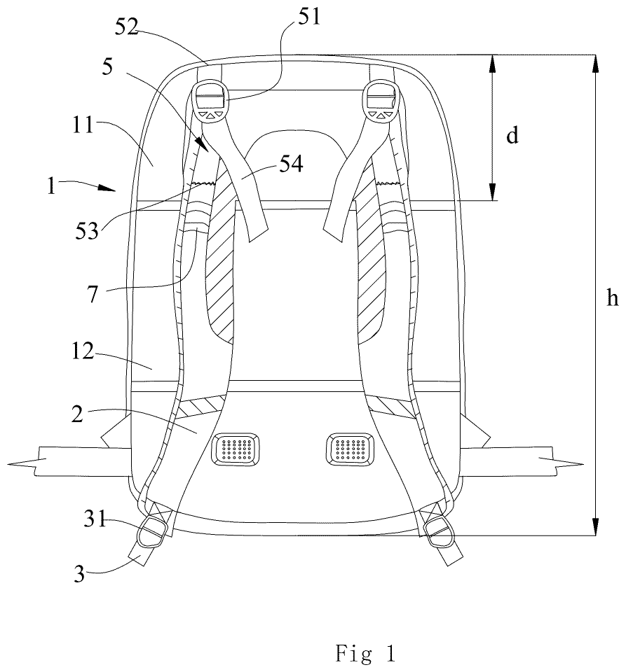

As shown in FIGS. 1-5, a close-fitting and adjustable massage structure, mainly comprising a back panel 1 and a shoulder strap 2 set on the back panel 1, mentioned back panel 1 comprises a connected upper part 11 and a lower part 12, the upper end of the shoulder strap 2 is connected to the back panel 1 at a position set on the connection line of the upper part 11 and the lower part 12 of the back panel 1, wherein the lower end of the shoulder strap 2 is connected to the lower part 12 of the back panel 1 through a first webbing 3, mentioned first adjustment component 31 for adjusting the length of the first webbing 3 is also provided between the first webbing 3 and the shoulder strap 2, the height h of the back panel 1 being: h≥390 mm, the height d of the upper part 11 being: 110 mm≤d≤147 mm. For the value of h, h explains and limits a reasonable size of the back panel of a backpack used by people from high school students to other ages of adults. The general adaptability of this size backpack is for 1) go to school, 2) commute; 3) travel. This kind of backpack users need to bear weight for a long time. The present invention aims at this specific demand, and fully considers the adult's height, back height, back thickness and other factors to create the value of h to achieve massage backpack products in reasonable range of back sizes. In order to improve the relatively complex structure, high cost and heavier weight of the product described in previous inventions, the present invention provides an innovative and new approach, namely: to have the shoulder strap stitch directly to the back panel of the backpack. If the size of this approach is not reasonable enough, it will cause a gap between the massage head on the strap and the area that needs to be massaged (from the upper back to the shoulders). After much research and testing it was discovered that having a huge number of people in different heights, body types, and back thicknesses, a solution is to find a common divisor and methods to create the best and suitable structures for a multitude of sizes for people of different body types, which can also form a tight-fitting effect, so as to achieve the best goal of good massage effect. As a result, we innovated the structure and size range of d. Only in this interval, our massage products can best match the body thickness of most adults people to achieve a better comfortable massage effect. The design of the second adjustment part (51), upper stitching (52), lower stitching (53), and protruding section (54), combined with the best size of d, achieves that the back panel of the massage backpack can be used by a multitude of people, which is comfortable and effective. A key point of the invention is: d is the best numerical range that we have verified through countless experiments and verifications during the past 2 years. This is not a numerical range that can be calculated by the existing formulas, this is an important invention which be created by now. At the same time, this innovative product will have a more scientific and effective massage effect. Therefore, this is part of the extended innovation and continuous innovation of the applicants massage creations. It is the result of creative invention that has been obtained through rounds of experiments, revisions, retests, and revisions.

Wherein the shoulder strap 2 is provided with a massage head 4 for back and shoulder massage inside, mentioned shoulder strap 2 is connected to the upper part 11 of the back panel 1 with a second webbing 5 for adjusting the position of the shoulder strap 2 and back and shoulder massage, the second webbing 5 is provided with a second adjusting part 51 for adjusting the length of the second webbing 5. The height h of the mentioned back panel 1 and the height d of the upper part 11 are the dimensions of the product after stitching. It is noted the invention may be just at least one shoulder strap without departing from the present invention. Preferably, the number of mentioned shoulder straps 2 is two and spaced along the width direction of the back panel 1.

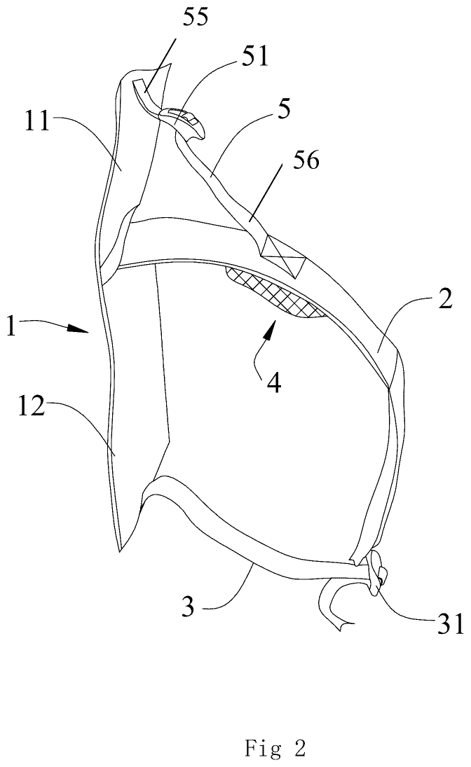

As shown in FIGS. 1-2, in order to facilitate the adjustment of the length of the webbing, the first adjustment part 31 and the second adjustment part 51 are both ladder buckles. This implementation uses the ladder buckle for the adjustment of the webbing, but it is not limited to the ladder buckle, but can also be other adjustment devices, such as belt-type pin and hole connection structure, or pawl and tooth slot mating structure.

As shown in FIG. 2, in order to make the best massage effect and the best fit with the human body, and the second webbing can be adjusted to keep the positioning of the back belt moving up and down accurately, and will not induce left and right shaking, the two ends of the second webbing 5 and the second adjustment component 51 are close and located on the substantially same vertical surface. As shown in FIG. 1, that is, the upper end seam 52, the lower end seam 53 and the second adjustment part 51 of the second webbing 5 are close and located on the substantially same vertical surface.

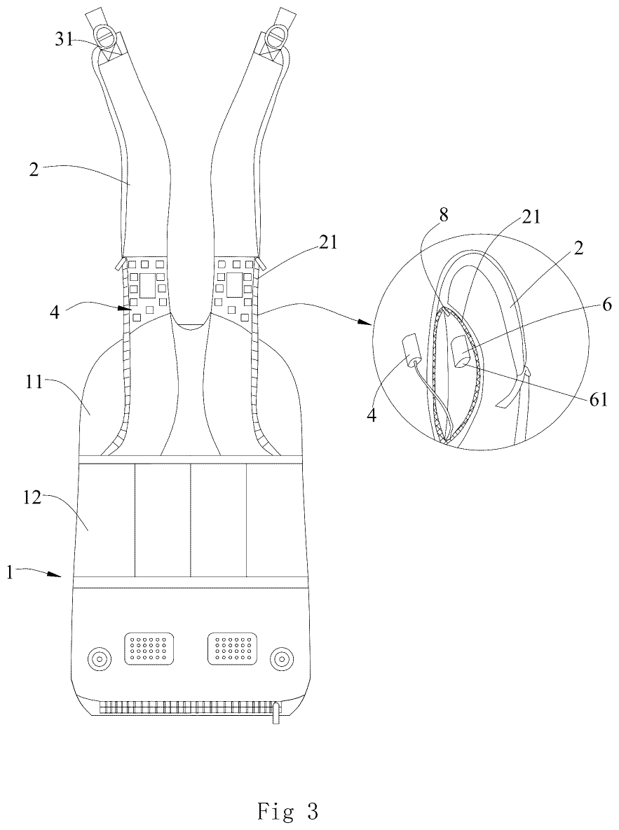

As shown in FIG. 3, in order to facilitate the installation of the massage head, the interior of the shoulder strap 2 is provided with a storage space 6 for the installation of the massage head 4, the storage space 6 is provided with a first opening 61 on one side to facilitate the massage head 4 and cable penetration into it, the storage space 6 is elastic and fastened to the outer circumference of the massage head.

As shown in FIG. 3, in order to facilitate the disassemble of the massage head, the side wall of the shoulder strap 2 is provided with a second opening 21 for opening and closing the internal space of the shoulder strap 2, mentioned second opening 21 through the fastener 8 to close the connection. This implementation of the fastener 8 is a zipper assemble, but also can be a dual lock, hook and loop (Velcro®) or other matching connection structure.

In order to fix the end of the second webbing to reduce noise, the shoulder strap 2 is also provided with a fastening part 7 that holds the second webbing 5 in place to reduce noise, and the fastening device 7 may be an elastic band or hook and loop (Velcro®). As shown in FIG. 1, the second webbing 5 outstretched section 54 can be fixed by the fastening device 7 to prevent the massage head in the vibration process to drive the outstretched section 54 resonance to reduce noise.

With reference to the FIGS. 1-5, an adjustable massage structure is provided, having a back panel (1) and at least one shoulder strap (2) set on the back panel (1), wherein the back panel (1) further comprises a connected upper part (11) and a lower part (12), wherein the upper end of the at least one shoulder strap (2) is connected to the back panel (1) at a position set on the connection line of the upper part (11) and the lower part (12) of the back panel (1), wherein the lower end of the at least one shoulder strap (2) is connected to the lower part (12) of the back panel (1) by means of a first webbing (3), wherein the at least one shoulder strap (2) is provided with a massage head (4) inside, wherein the at least one shoulder strap (2) and the upper part (11) of the back panel (1) is connected with a second webbing (5) for adjustment of the shoulder strap (2), wherein the second webbing (5) is provided with a second adjustment part (51) for adjusting the length of the second webbing (5). There may be two shoulder straps (2) spaced along the width of the backboard (1). The second adjustment part (51) may be a ladder buckle (as shown in FIG. 1). The ends of the second webbing (5) and the second adjustment part (51) are located on a substantially vertical surface, wherein the second webbing (5) is divided into two sections, an upper section (55) and a lower section (56), wherein the upper section (55) and the lower section (56) are integrated through the second adjustment part (51). The interior of the shoulder strap (2) is provided with a storage space (6) for the installation of the massage head (4). A side wall of the shoulder strap (2) is provided with a second opening (21) for opening and closing the internal space of the shoulder strap (2), wherein the second opening (21) is connected by fasteners (8) for closure. The shoulder straps (2) may also be provided with a fastening part (7) to hold the second webbing (5) to reduce noise, the fastening part (7) is an elastic band or hook and loop (Velcro®).

The massage structure close-fitting to users body and adjustable structure, with a bag body connected thereto, wherein the bag body being fixed or detachably connected to the back panel. The height h of the back panel (1) being greater than or equal to 390 mm, and the height d of the upper part (11) being greater than or equal to 110 mm and less than or equal to 147 mm. The storage space (6) is provided with a first opening (61) on one side to facilitate the massage head (4) and cable through it. The storage space (6) is elastic and fastened to the outer circumference of the massage head (4).

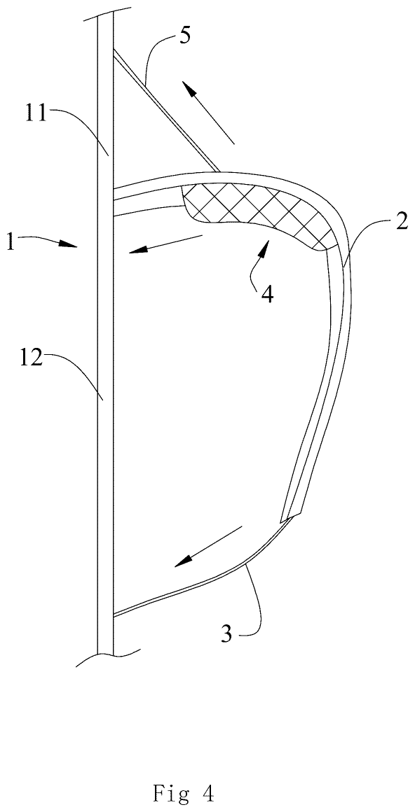

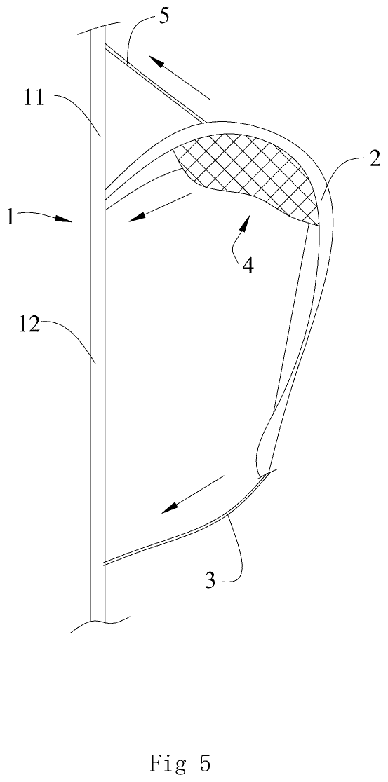

The working principle and process of this implementation are as follows. As shown in FIGS. 1-5, wherein the connection position of shoulder straps 2 and the back panel 1 will divide its back panel 1 into the upper part 11 and lower part 12, and the lower part 12 connected with the first webbing 3 is mainly used to adjust the position of backpack to fit on the human body, while adjusting the massage head 4 and the general position of the human shoulder and back, tighten the second webbing 5 can further adjust the massage head 4 on right position of human shoulder position, while the second webbing 5 provide the shoulder straps 2 upward tilting pulling force as shown in FIGS. 4-5, while under the gravity of the backpack, the ends of the shoulder straps are also pulled, so that the massage head 4 and the shoulder fully fit closely, to enhance the massage experience of the user in the case of backpack. Among them, the size of the innovative d is crucial to the closeness of the massage head.

Implementation II. As shown in FIGS. 1-5, a massage backpack, comprises a snug and adjustable massage structure described in implementation I and a bag body connected thereto, wherein the bag body being fixedly or detachably connected to the back panel.

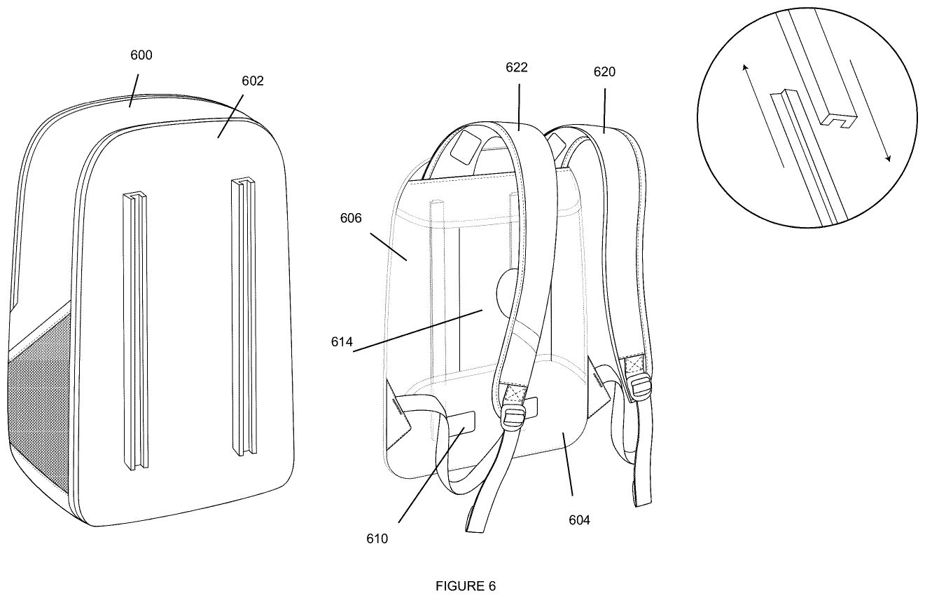

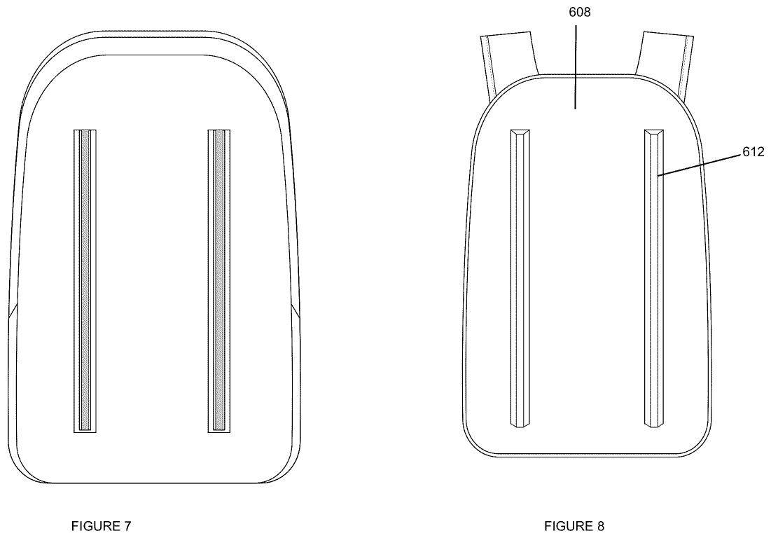

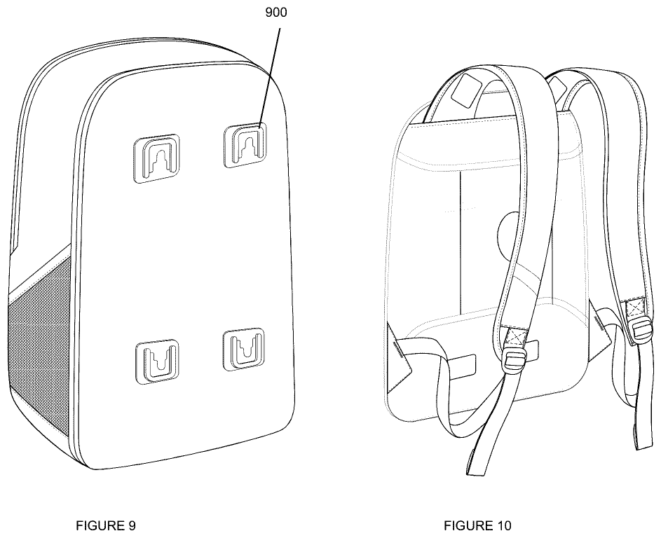

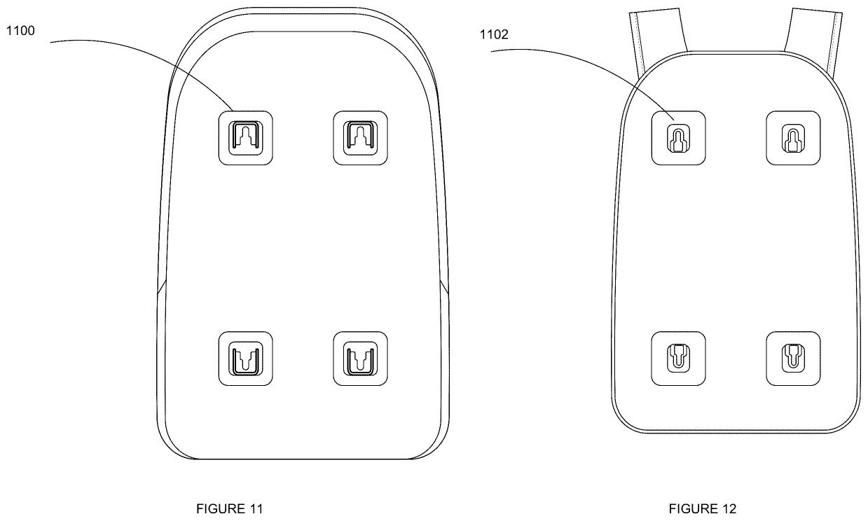

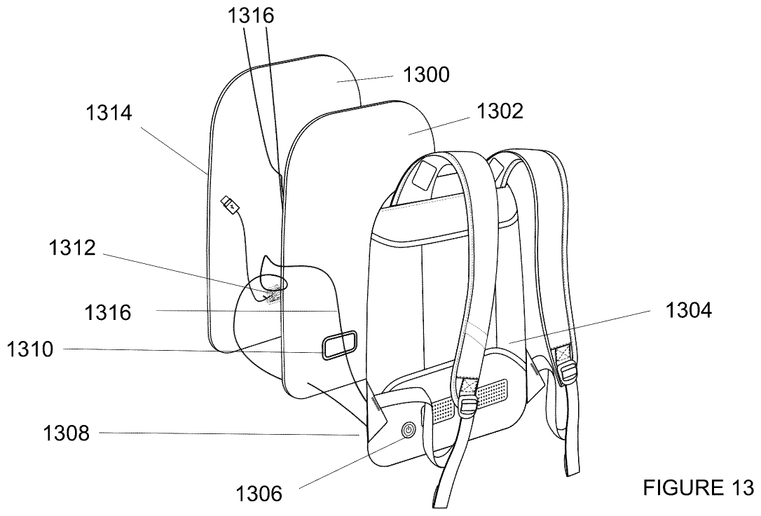

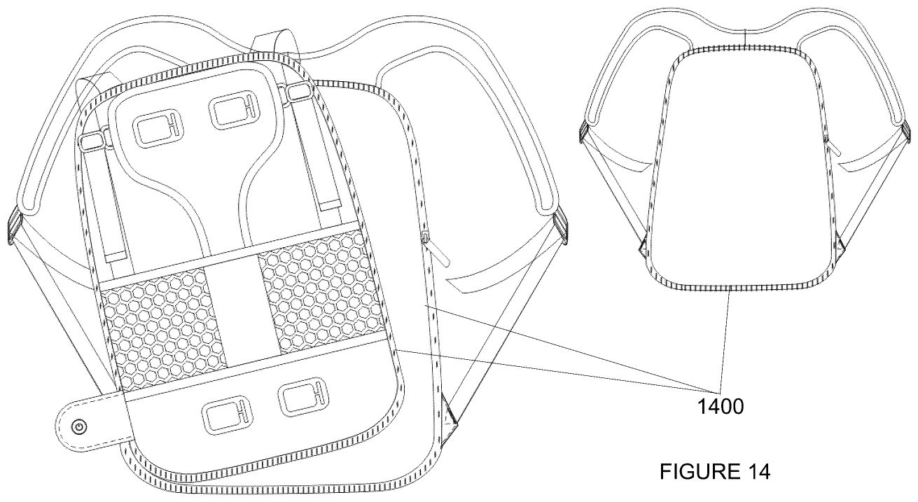

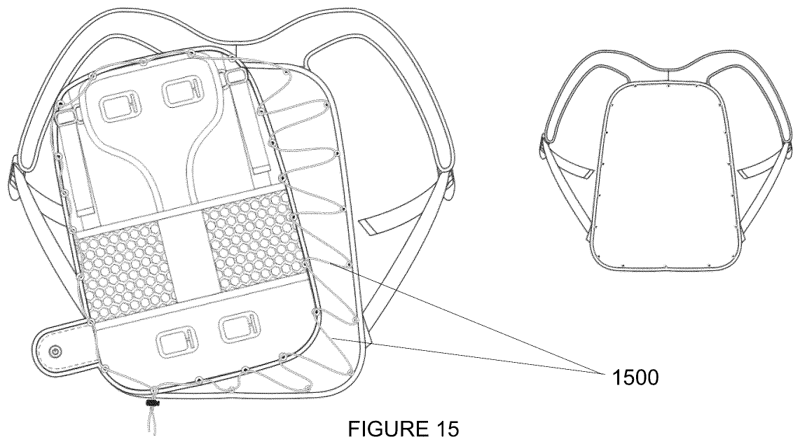

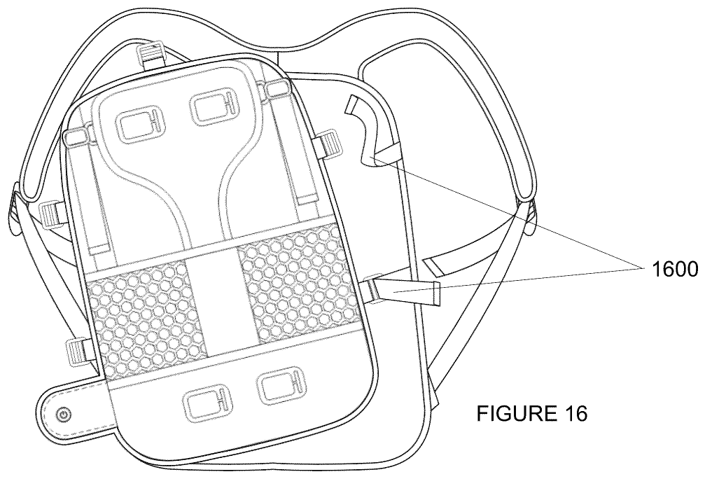

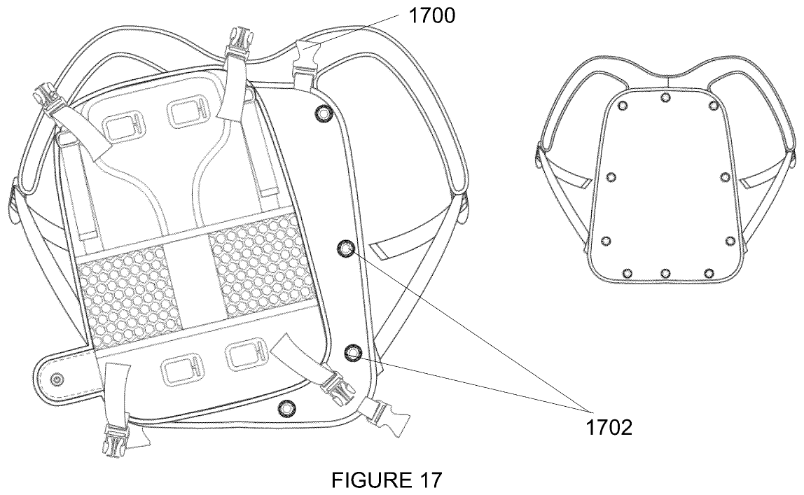

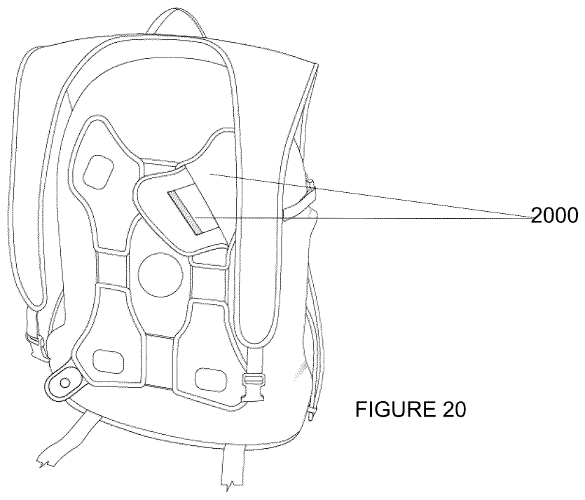

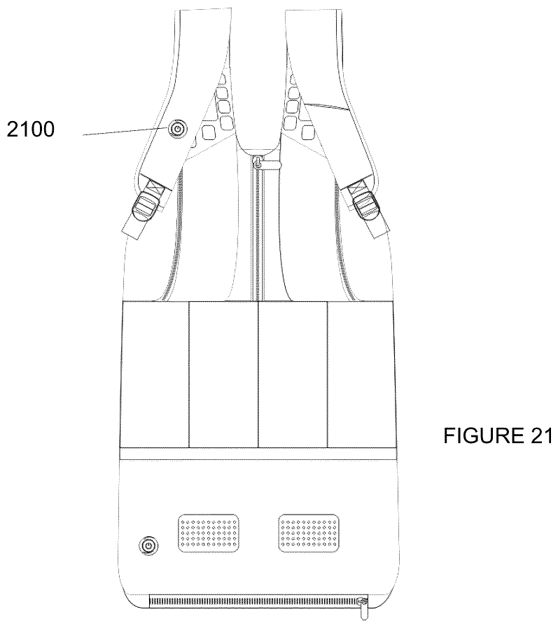

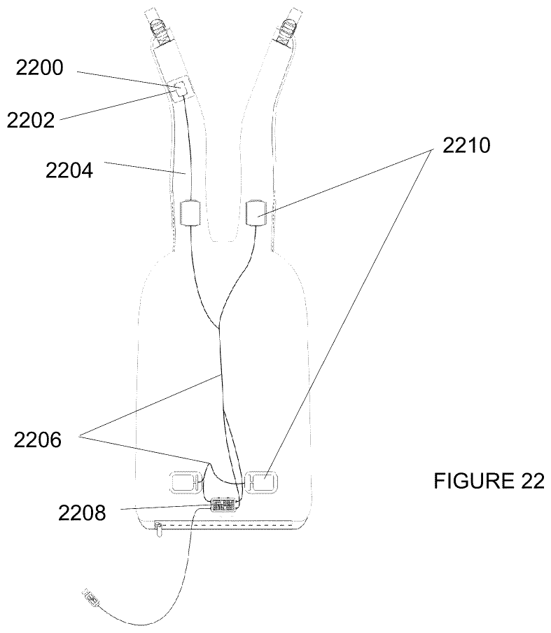

With reference to FIGS. 6, 7, 8, 9, 10, 11, 12, 13, 14, 15, 16, 17, 18, 19, 20, 21 and 22. A massaging apparatus system with a convenient manufacturing and removable structure, comprising, a body (600) with a first back panel (602), a second massage back panel (604), the second massage back panel is removable and attachable to the first back panel, wherein the second massage back panel has a first inner layer (1308), a second inner layer (1300), a first outer layer (606, 1304) and a second outer layer (608, 1314), wherein the second massage back panel has at least one massage head (610, 1310), wherein the first outer layer (606) is configured to communicate with a users back for massage performance, the second outer layer (608) is configured to attach to the first back panel by at least a pair of detachable accessories (e.g. 612), wherein the second massage back panel is flexible, wherein between the first inner layer and the second inner layer there is at least one layer of flexible material (614) to protect the inner massage apparatus inside, to improve the comfort to the user and to achieve the effect that the user can fit apparatus more closely to their body, wherein a control circuit (1312) having at least one cable (1316) connects to the at least one massage head (1310, 2210). The detachable accessories may be selected from the group consisting of track, buckles (1700), hook and loop (2000) (Velcro®), webbing (1600), rope, straps (1500), slots, power stickers, magnets, buttons (1702), zippers (1400). Note that rope and strap are depicted by (1500) and (612) is a slot or track and (900, 1100, 1102) are buckles. FIGS. 11 and 12 depict an example of detachable accessories (1100, 1102). The detachable accessories may be flexible to achieve the effect that the user can fit the second massage back panel very closely to their own body. The control circuit is stored between the first inner layer and the second inner layer of the second massage back panel.

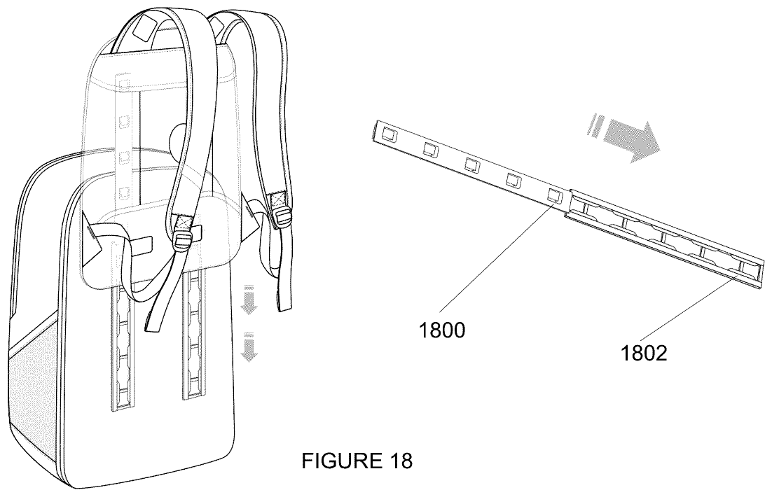

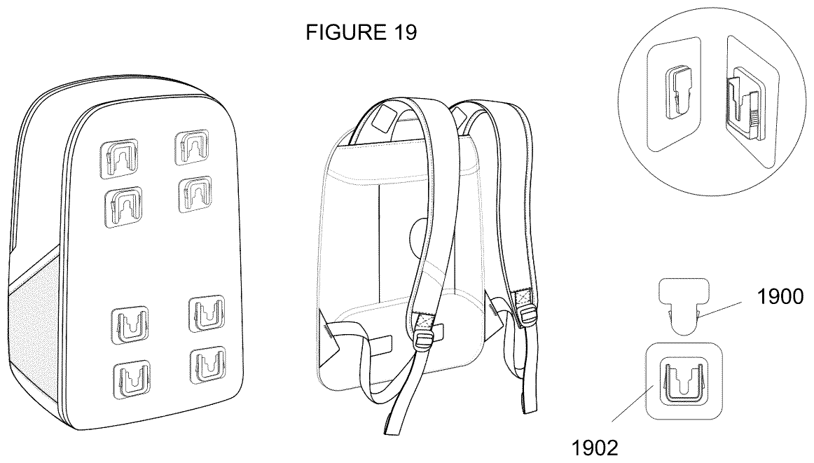

The second massage back panel may have at least one shoulder strap (620, 622, 2204). There may be a function control board (1306, 2100, 2200) in communication with the control circuit (2208). The function control board (2200) may be connected to the control circuit (2208) by a cable (2206). The function control board may be fixed on the body with a substantially rigid material base (2202) to keep it firmly in place. The function control board may be settled on the shoulder strap. The flexible material may be selected from the group consisting of metal, elastic fabric, foamy material, neoprene, rubber, silica, leather, leatherette, synthetic. There may be a pair of accessories that have a blocking system, wherein the blocking system prevents the accessories from being taken off unless the blocking system is released. FIG. 18 depicts an example of a slot with a blocking system (1800, 1802) that prevents accessories from being taken off unless the blocking system is released. FIG. 19 depicts another example of a blocking system that prevents the accessories from being taken off. As can be seen there is a base portion (1902) and a panel portion (1900) and the panel portion (1900) clicks into the base portion (1902) to provide a second massage back panel that is removable and attachable to the first back panel. When the pair of accessories are tracks or slots or buckles, there is one or more activity convex points on the male part of blocking system, and one or more activity convex points release button on the female part of the blocking system, when the pair of accessories are combined with each other and the male part slides downward, this activity convex points is movable, when the male part is pushed downward, the activity convex points on the blocking system will retract, so that the male part can slide downward directly smoothly to reach the position it should reach. When the male part of the accessory slides upward in the opposite direction, the activity convex points on the blocking system will not retract, and then the male part of the accessory will not come out automatically easily. It is necessary to manually press the activity convex points release button on the female part of accessory to make the activity convex points retract in order to remove the male part. This can make the massage back piece, while in use, will not easily move to wrong position or taken off.

The first back panel has more accessories (900) for the second massage back panel to attach to and configured for users to select the most suitable position for massaging. There may be a foam material (1302) with a thickness of at least 1 mm (this has been tested and determined to be the minimum thickness required to protect the massage apparatus) and attached between the first inner layer and the massage head. There may be a foam material with a thickness of at least 1 mm attached between the massage apparatus and the massage head. The first back panel is flexible to achieve the effect that the user can fit the body very closely to their own body.

Although the present invention is illustrated and described using specific implementations and alternatives thereto, it should be understood that various variations and modifications may be implemented as long as they do not depart from the spirit of the present invention. Accordingly, it should be understood that the present invention is not limited in any sense except by the accompanying claims and their equivalents.

I claim:

1. A massaging apparatus system with a convenient manufacturing and removable structure, comprising,
a body with a first back panel and a second massage back panel, wherein the second massage back panel is removable and attachable to the first back panel,
wherein the second massage back panel has a first inner layer, a second inner layer, a first outer layer and a second outer layer,
wherein the second massage back panel has at least one massage head,
wherein the first outer layer is configured to communicate with a users back for massage performance, the second outer layer is configured to attach to the first back panel by at least a pair of detachable accessories,
wherein the second massage back panel is flexible,
wherein between the first inner layer and the second inner layer there is at least one layer of flexible material,
wherein a control circuit having at least one cable connects to the at least one massage head.

2. A massaging apparatus system with a convenient manufacturing and removable structure as in claim 1, wherein the detachable accessories are selected from the group consisting of track, buckles, hook and loop, webbing, rope, straps, slots, power stickers, magnets, buttons, zippers.

3. A massaging apparatus system with a convenient manufacturing and removable structure as in claim 1, wherein the detachable accessories are flexible to achieve the effect that the user can fit the second massage back panel very closely to their own body.

4. A massaging apparatus system with a convenient manufacturing and removable structure as in claim 1, wherein the control circuit is stored between the first inner layer and the second inner layer of the second massage back panel.

5. A massaging apparatus system with a convenient manufacturing and removable structure as in claim 1, the second massage back panel further comprising a shoulder strap.

6. A massaging apparatus system with a convenient manufacturing and removable structure as in claim 1, further comprising a function control board in communication with the control circuit.

7. A massaging apparatus system with a convenient manufacturing and removable structure as in claim 3, wherein the function control board is connected to the control circuit by a cable.

8. A massaging apparatus system with a convenient manufacturing and removable structure as in claim 3, wherein the function control board is fixed on the body with a substantially rigid material base to keep it firmly in place.

9. A massaging apparatus system with a convenient manufacturing and removable structure as in claim 3, wherein the function control board is settled on the shoulder strap.

10. A massaging apparatus system with a convenient manufacturing and removable structure as in claim 1, wherein the flexible material is selected from the group consisting of metal, elastic fabric, foamy material, neoprene, rubber, silica, leather, leatherette, synthetic.

11. A massaging apparatus system with a convenient manufacturing and removable structure as in claim 1, further comprising a pair of accessories that have a blocking system, wherein the blocking system prevents the accessories from being taken off unless the blocking system is released.

12. A massaging apparatus system with a convenient manufacturing and removable structure as in claim 1, wherein the first back panel has more accessories for the second massage back panel to attach to and configured for users to select a most suitable position for massaging.

13. A massaging apparatus system with a convenient manufacturing and removable structure as in claim 1, further comprising a foam material with a thickness of at least 1 mm and attached between the first inner layer and the massage head.

14. A massaging apparatus system with a convenient manufacturing and removable structure as in claim 1, further comprising a foam material with a thickness of at least 1 mm attached between the massage apparatus and the massage head.

15. A massaging apparatus system with a convenient manufacturing and removable structure as in claim 1, the first back panel is flexible to achieve the effect that the user can fit the body very closely to their own body.
